(19) United States
(12) Patent Application Publication
(10) Pub. No.: US 2003/0099114 A1
(43) Pub. Date: May 29, 2003

(54) Disk box with flashing circuit

(76) Inventor: Kazuhiro Ohara, Yokohama (JP)

Correspondence Address: KAZUHIRO OHARA, 235 Chung-Ho, Box 8-24, Taipei, TW

(21) Appl. No.: 09/994,457

(22) Filed: Nov. 28, 2001

(51) Int. Cl. F21V 7/04

(52) U.S. Cl. 362/555

(57) ABSTRACT

A disk box with a flashing circuit comprises a box seat, a positioning disk, and an upper cover. A circuit board with light emitting diodes and batteries are installed at a bottom side of the box seat. A lateral side and a flat portion at an end of a positioning disk are adhered with drawings. Thereby, by above structure, the positioning disk may cover the box seat, and then the upper cover covers the positioning disk so as to be formed as a disk box. Thereby, as the user presses the push button so that power of the battery flows to the circuit board to conduct the light emitting diodes, a flash effect will present to inform the user to keep attention.

### FIELD OF THE INVENTION

The present invention relates to disk boxes, and especially to a disk box with a flashing circuit, which can present a flashing effect so as to attract the attentions of the consumers.

### BACKGROUND OF THE INVENTION

In modern societies, optic disks, such as CDs, VCDs, DVDs, are widely used as recording mediums. In general, the disks are packed by a transparent box with a sheet having drawings adhered thereon, as that illustrated in the FIG. 1. Thereby, users may select the desired disks according to the indications of the drawings. However, since almost optic disks use such kind of design, it becomes too dull to present the special features of a product. Moreover, it is often that one has many optic disks and thus, to manage the disks becomes a complicated and heavy work so that to find one disk is very difficult and time-consumed. This is especially important for the sellers or those having many optic disks.

Therefore, there is an eager demand for a novel design of disk box which may improve the defects in the prior design and may present the special features of the disk received therein.

### SUMMARY OF THE INVENTION

Accordingly, the primary object of the present invention is to provide a disk box with a flashing circuit which may attract the attention of the user so as to increase the selling amount.

Another object of the present invention is to provide a disk box with a flashing circuit, wherein a plurality of drawings are matched with a plurality of different colors so as to present the features of the product.

A further object of the present invention is to provide a disk box with a flashing circuit, wherein the flashing circuit is a wireless circuit. It is controlled by a wireless transmitter so as to actuate and control the flashing operation of a circuit board in the disk box.

To achieve object, the present invention provides a disk box with a flashing circuit comprises a box seat, a positioning disk, and an upper cove. A circuit board with light emitting diodes and batteries are installed at a bottom side of the box seat. A lateral side and a flat portion at one end of a positioning disk are adhered with drawings. Thereby, by above structure, the positioning disk may cover the box seat, and then the upper cover covers the positioning disk. Therefore, a disk box is formed. Thereby, as the user presses the push button so that power of the battery flows to the circuit board to conduct the light emitting diodes, a flash effect may be presented so as to attract the user's attention.

The various objects and advantages of the present invention will be more readily understood from the following detailed description when read in conjunction with the appended drawing.

### BRIEF DESCRIPTION OF THE DRAWINGS

FIG. 1 is an exploded perspective view of a prior disk box.

FIG. 2 is an exploded perspective view of the present invention.

FIG. 3 is a perspective view of the present invention showing the upper cover of the present invention is opened.

FIG. 4 shows the perspective view of the present invention.

FIG. 5 is a partial cross section view of the present invention.

FIG. 6 shows an application of the present invention.

FIG. 7 shows an application of the present invention, wherein the present invention is controlled wirelessly so as to present a flash effect.

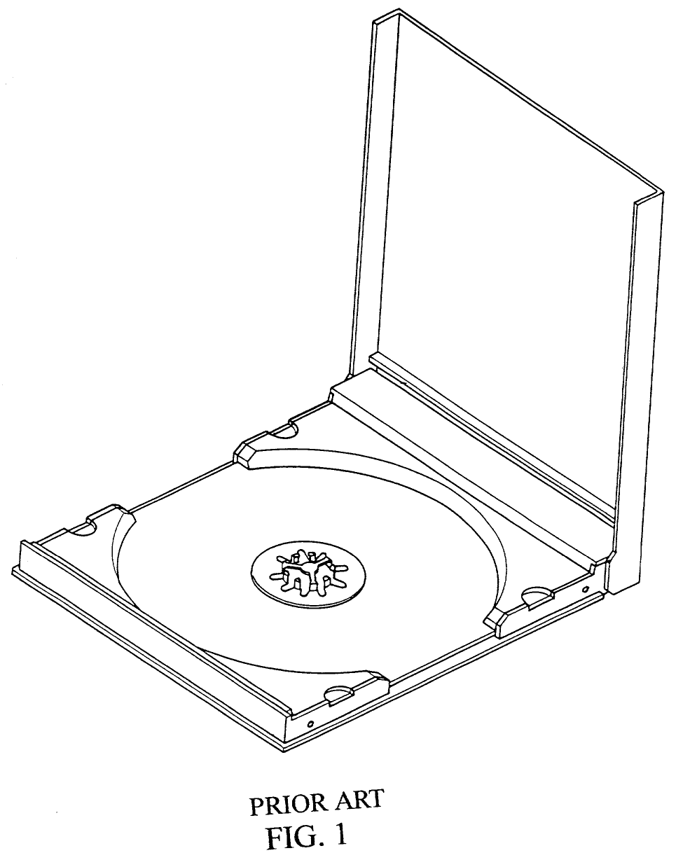

### DETAILED DESCRIPTION OF THE PREFERRED EMBODIMENTS

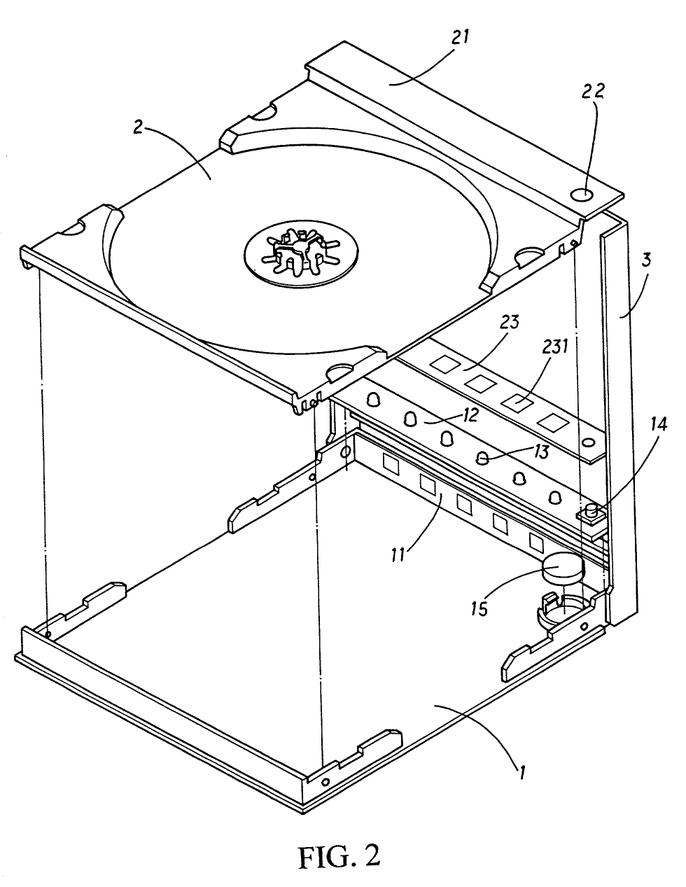

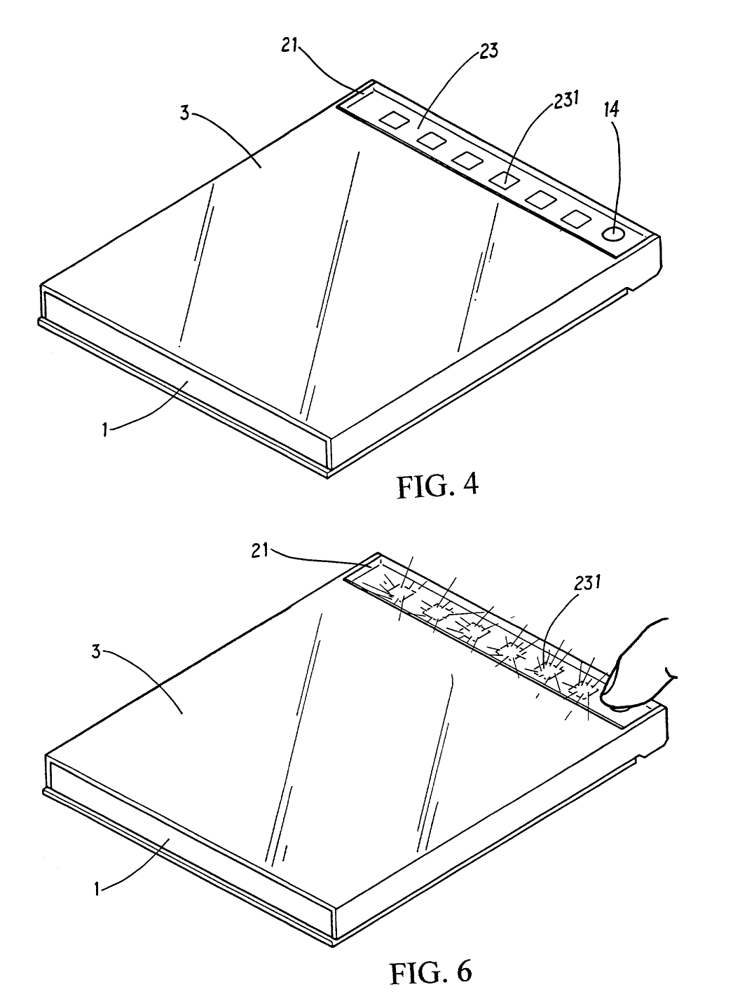

Referring to FIGS. 2-5, the disk box of the present invention is illustrated. The disk box includes a box seat 1, a positioning disk 2, and an upper cover 3. The positioning disk 2 can receive a disk therein (not shown) and is positioned above the box seat 1.

In the present invention, drawings 11 are adhered to a lateral side of the box seat 1 which is pivotally connected to the upper cover 3. A bottom of the box seat 1 has a circuit board 12. A surface of the circuit board 12 is installed with a plurality of light emitting diodes 13 and a push button 14. The backside of the circuit board 12 has a flashing circuit (not shown) which can be connected to a battery 15. The flashing circuit serves to control the flashing effect of the light emitting diodes 13 (these light emitting diodes 13 may emit lights of different colors).

An upper side of the positioning disk 2 has a flat section 21. The flat section 21 has a through hole 22. The push button 14 may pass through the through hole 22. A back surface of the push button 14 is adhered with a transparent drawing 23.

The upper cover 3 has ears (not shown) at two ends and is engaged with the box seat 1. Thereby, the upper cover 3 may pivotally rotate with respect to the box seat 1 and cover the box seat 1.

By above structure, the positioning disk 2 may cover the box seat 1, and then the upper cover 3 covers the positioning disk 2 so as to form as a disk box. Thereby, as the user presses the push button 14 so that power of the battery 15 flows to the circuit board 12 to conduct the light emitting diodes 13, a flash effect will present (referring to FIG. 6) to attract the user's attention.

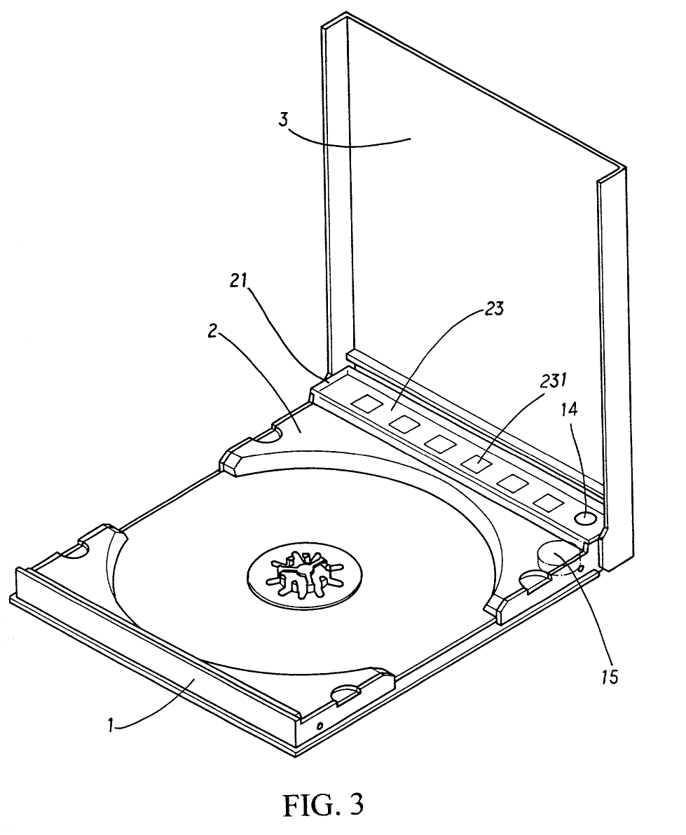

Referring to FIG. 3, it is shown that the drawings 23 are adhered on the frame holes 231 of the positioning disk 2. The frame holes 231 are positioned corresponding to the light emitting diodes 13. Therefore, texts may be written on the drawings 23. Light emitted from the light emitting diodes 13 transmits through the frame holes 231 so as to attract the user's attention.

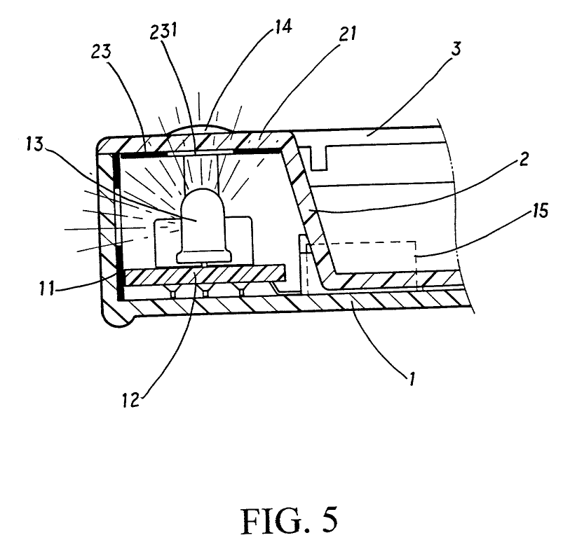

Furthermore, as shown in the FIG. 5, the positioning disk 2 cover the box seat 1 so as to press and confine the circuit board 12 and the battery 15.

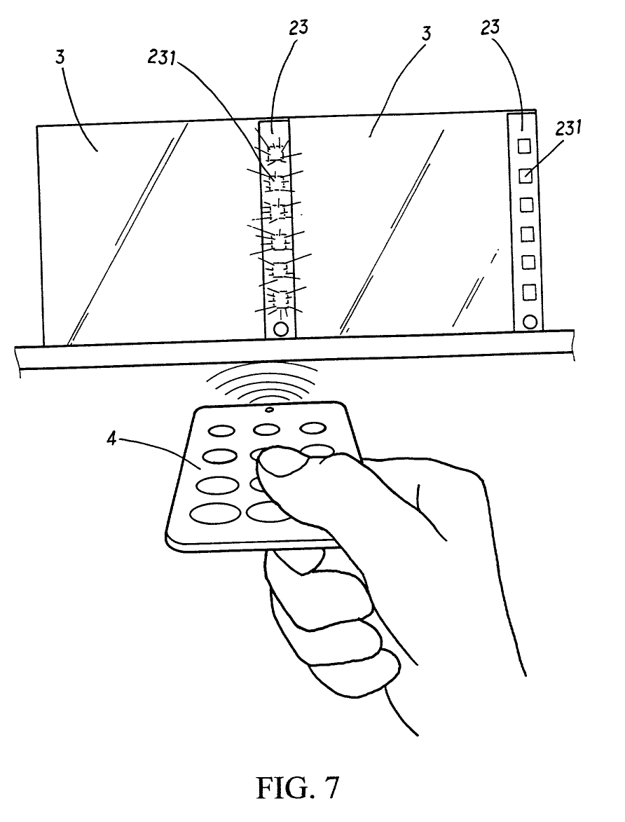

With reference to FIG. 7, another embodiment of the present invention is illustrated. The flashing circuit is a wireless circuit which may receive signals wirelessly. Thereby, it can be controlled by a wireless transmitter 4 to actuate and control the flashing operation of the circuit board 12. Further, the effect of searching and controlling is achieved.

It should be noted that in the present invention, the drawings 11 or 23 are matched with light emitting diodes 13 of different colors so as to present the features of the product.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A disk box with a flashing circuit comprising a box seat, a positioning disk, and an upper cover; the positioning disk being capable of receiving a disk therein and being positioned above the box seat; the upper cover having ears at two ends and being engaged with the box seat; thereby, the upper cover being pivotally rotating with respect to the box seat and cover the box seat; characterized in that:
a drawing is adhered to a lateral side of the box seat which is pivotally connected to the upper cover; a bottom of the box seat has a circuit board; a surface of the circuit board is installed with a plurality of light emitting diodes and a push button; a backside of the circuit board has a flashing circuit which is connected to a battery; the flashing circuit serves to control the flashing effect of the light emitting diodes; and
an upper side of the positioning disk has a flat section; the flat section has a through hole; the push button passes through the through hole; a back surface of the push button is adhered with a transparent drawing;
wherein by above structure, the positioning disk covers the box seat, and then the upper cover covers the positioning disk so as to be formed as a disk box; thereby, as a user presses the push button so that power of the battery flows to the circuit board to conduct the light emitting diodes; consequently, a flash effect presents so as to attract the user's attention.

2. The disk box with a flashing circuit as claim in claim 1, wherein the drawing adhere on the frame holes of the positioning disk; the frame holes are formed at positions corresponding to the light emitting diodes; therefore, texts are written on the drawings; light emitted from the light emitting diodes transmits through the frame holes so as to attract the user's attention.

3. The disk box with a flashing circuit as claim in claim 1, wherein the positioning disk covers the box seat to press and confine the circuit board and the battery.

4. The disk box with a flashing circuit as claim in claim 1, wherein the flashing circuit is a wireless circuit which is controlled by a wireless transmitter so as to actuate and control the flashing operation of the circuit board.

5. The disk box with a flashing circuit as claim in claim 1, wherein the drawings are matched with light emitting diodes of different colors to present the features of a product.
